(19) United States
(12) Patent Application Publication
(10) Pub. No.: US 2026/0119121 A1
(43) Pub. Date: Apr. 30, 2026

(54) METHOD

(71) Applicant: TOYOTA JIDOSHA KABUSHIKI KAISHA, Toyota-shi (JP)

(72) Inventors: Yukiko SONOHARA, Obu-shi (JP); Hirofumi MORISHITA, Anjo-shi (JP)

(73) Assignee: TOYOTA JIDOSHA KABUSHIKI KAISHA, Toyota-shi (JP)

(21) Appl. No.: 19/365,447

(22) Filed: Oct. 22, 2025

(30) Foreign Application Priority Data
Oct. 28, 2024 (JP) 2024-189208

(51) Int. Cl. G06F 3/16; G06Q 30/01; H04N 23/62; G10L 15/18

(52) U.S. Cl. CPC G06F 3/167; G06Q 30/01; H04N 23/62; G10L 15/18

(57) ABSTRACT

A method executed by an information processing apparatus that includes a controller, an imager, and an input interface includes executing, by the controller, operations including acquiring consent from a customer regarding recording of customer engagement audio via the input interface, starting capturing an image using the imager after the consent is acquired, and starting audio recording when a predetermined condition is met, and the predetermined condition includes a first condition that a staff member is reflected in an image of the imager.

### CROSS-REFERENCE TO RELATED APPLICATION

This application claims priority to Japanese Patent Application No. 2024-189208 filed on October 28, 2024, the entire contents of which are incorporated herein by reference.

### TECHNICAL FIELD

The present disclosure relates to a method.

### BACKGROUND

Technology for analyzing dialogue content is known. For example, Patent Literature (PTL) 1 discloses a dialogue analysis system that records dialogue data based on audio data of recorded dialogue content and extracts dialogues that match conditions specified by the user from the dialogue data to display a list thereof.

### CITATION LIST

### Patent Literature

PTL 1: JP 2019-028910 A

### SUMMARY

Store staff record audio during customer engagement such as sales talks and utilize the recorded audio for purposes such as creating customer reports. However, the staff may forget to perform the operation to start the audio recording due to concentrating on the customer engagement.

It would be helpful to improve technology for analyzing dialogue content.

A method according to an embodiment of the present disclosure is a method executed by an information processing apparatus that includes a controller, an imager, and an input interface, the method including executing, by the controller, operations including:

acquiring consent from a customer regarding recording of customer engagement audio via the input interface;

starting capturing an image using the imager after the consent is acquired; and

starting audio recording when a predetermined condition is met,

wherein the predetermined condition includes a first condition that a staff member is reflected in an image of the imager.

According to an embodiment of the present disclosure, technology for analyzing dialogue content is improved.

### BRIEF DESCRIPTION OF THE DRAWINGS

In the accompanying drawings:

FIG. 1 is a block diagram illustrating a schematic configuration of an information processing apparatus according to an embodiment of the present disclosure; and

FIG. 2 is a flowchart illustrating operations of the information processing apparatus according to an embodiment of the present disclosure.

### DETAILED DESCRIPTION

Embodiments of the present disclosure will be described below, with reference to the drawings.

### Outline of Present Embodiment

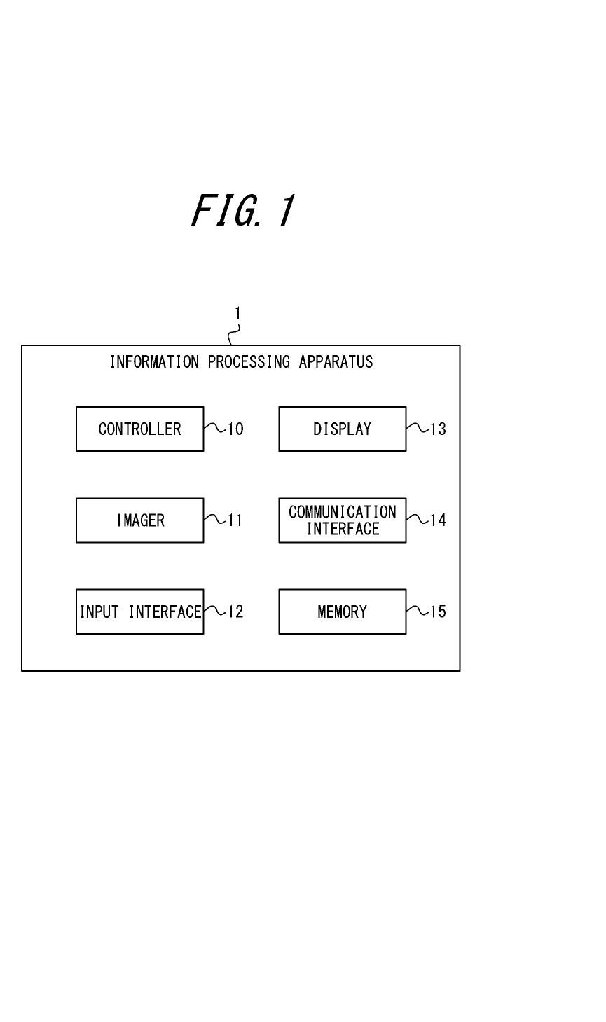

With reference to FIG. 1, an overview of the information processing apparatus 1 according to the embodiment of the present disclosure will be described. In this embodiment, the information processing apparatus 1 is a computer such as a laptop computer, tablet, or smartphone. The information processing apparatus 1 is used, for example, by staff in a store. The information processing apparatus 1 is capable of recording the voices of customers and staff.

First, an outline of the present embodiment will be described, and details thereof will be described later. The method according to this embodiment is executed by the information processing apparatus 1, which includes a controller 10, an imager 11, and an input interface 12. The controller 10 obtains consent from a customer regarding recording of customer engagement audio via the input interface 12. After consent is obtained, the controller 10 starts imaging by the imager 11. The controller 10 starts audio recording when a predetermined condition is met. The predetermined condition includes a first condition that staff is captured in the image by the imager 11.

According to this embodiment, if the predetermined condition is met, recording is automatically started. As a result, recording data can be reliably obtained without the staff performing the recording start operation.

### Configuration of Information Processing Apparatus 1

As illustrated in FIG. 1, the information processing apparatus 1 includes a controller 10, an imager 11, an input interface 12, a display 13, a communication interface 14, and a memory 15.

The controller 10 includes at least one processor, at least one programmable circuit, at least one dedicated circuit, or a combination of these. The processor is, for example, a general purpose processor such as a central processing unit (CPU) or a graphics processing unit (GPU), or a dedicated processor that is dedicated to specific processing, but is not limited to these. The programmable circuit is a field-programmable gate array (FPGA), for example, but is not limited to this. The dedicated circuit is an application specific integrated circuit (ASIC), for example, but is not limited to this. The controller 10 executes various processes related to the operations of the information processing apparatus 1 and controls each component of the information processing apparatus 1.

The imager 11 includes any imaging module capable of capturing the surroundings of the information processing apparatus 1. The imaging module includes one or more cameras. Each camera is positioned appropriately on the information processing apparatus 1 to capture the surroundings of the information processing apparatus 1. In this present embodiment, the imager 11 includes an in-camera capable of capturing a subject on the user side of the information processing apparatus 1 (for example, staff). The imager 11 may further include an out-camera capable of capturing a subject on the opposite side of the user (for example, a customer).

The input interface 12 is equipped with one or more interfaces for input. The interface for input includes a microphone for accepting voice input from customers and staff. The interface for input may include, for example, a physical key, a capacitive key, a pointing device, or a touch screen integrally provided with the display of the display 13. The input interface 12 accepts an operation for inputting information to be used for the operations of the information processing apparatus 1. The input interface 12 may be connected to the information processing apparatus 1 as an external input device, instead of being included in the information processing apparatus 1. As a connection method, any method such as Universal Serial Bus (USB), High-Definition Multimedia Interface (HDMI^{®}) (HDMI is a registered trademark in Japan, other countries, or both), or Bluetooth^{®} (Bluetooth is a registered trademark in Japan, other countries, or both) can be used.

The display 13 includes one or more interfaces for display. The interface for display is, for example, a display that shows information as images. The display is, for example, a liquid crystal display (LCD) or an organic electro-luminescent (EL) display. The display 13 displays information obtained by the operations of the information processing apparatus 1. The display 13 may be connected to the information processing apparatus 1 as an external display device, instead of being included in the information processing apparatus 1. As a connection method, any method such as USB, HDMI^{®}, or Bluetooth^{®} can be used.

The communication interface 14 includes at least one interface for communication for connecting to a network. The interface for communication is compliant with mobile communication standards such as the 4th generation (4G) standard and the 5th generation (5G) standard, or a wired local area network (LAN) communication standard or a wireless LAN communication standard, for example, but is not limited to these and may be compliant with any communication standard.

The memory 15 includes one or more memories. The memories included in the memory 15 may each function as, for example, a main memory, an auxiliary memory, or a cache memory. The memory 15 stores any information to be used for operations of the information processing apparatus 1. The memory 15 may store, for example, a system program, an application program, and embedded software. In this present embodiment, the memory 15 may store any data related to customer engagement such as sales talks. The information stored in the memory 15 may be updated based on information acquired from the network via the communication interface 14.

### Flow of Operations of Information Processing Apparatus 1

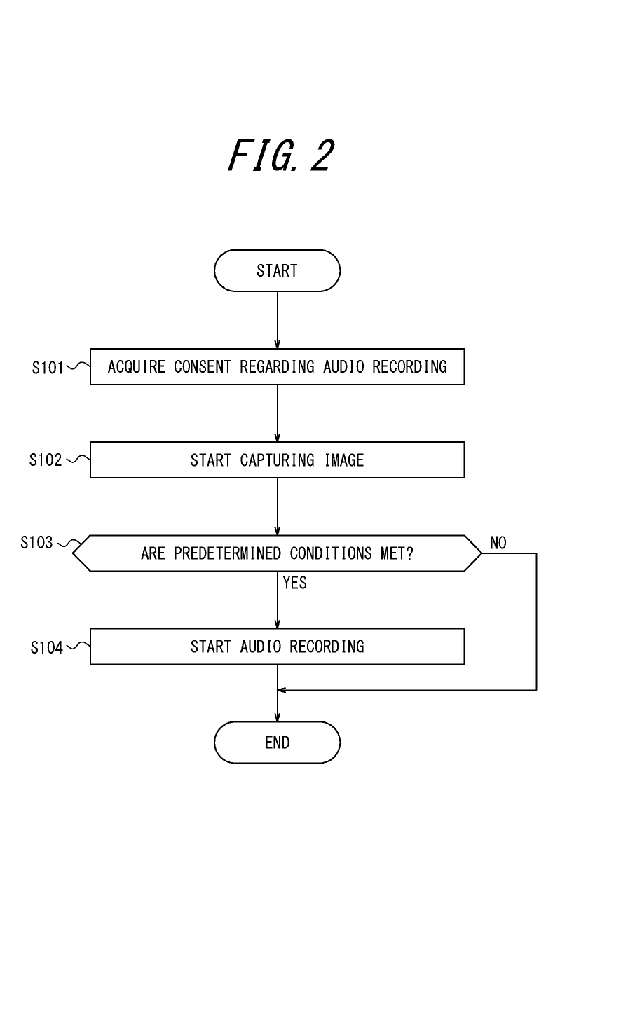

Operations of the information processing apparatus 1 according to the present embodiment will be described with reference to FIG. 2. In the following, communication between the respective parts of the information processing apparatus is performed via the communication interface 14.

S101: The controller 10 of the information processing apparatus 1 acquires consent from a customer regarding recording of customer engagement audio via the input interface 12.

In this embodiment, the controller 10 acquires consent by detecting a consent phrase that suggests the customer's consent regarding recording from the utterance input to the input interface 12 (for example, a microphone). The controller 10 may detect the consent phrase by comparing the phrases stored in the memory 15 with the content of the utterance. The comparison may utilize natural language processing such as morphological analysis, syntactic analysis, semantic analysis, contextual analysis, and co-reference analysis, along with a learning model trained in advance by machine learning. The learning model may be trained to take the content of the utterance as input and output the comparison result with the phrases stored in the memory 15. The features of the learning model may be specific words or phrases, such as "recording" or "consent."

The consent phrase may include phrases indicating consent to the recording of customer engagement audio, such as "I consent to the recording of customer engagement audio." The consent phrase may include staff questions regarding consent and the customer's responses to those questions, such as "Do you consent to the recording of customer engagement audio?" and "Yes." The consent phrase is not limited to the above examples and may include any phrase.

The controller 10 may display the question on the display 13 to prompt the staff to ask the question. This allows the staff to ensure that they ask the question regarding consent and reliably obtain consent even if they forget to ask or forget the content of the question.

The controller 10 may acquire consent by obtaining the customer's signature input to the input interface 12 (for example, a touch screen). Alternatively, the controller 10 may display a screen requesting consent on the display 13 of the information processing apparatus 1 and acquire consent by accepting the customer's selection of consent via the input interface 12 (for example, selecting a button indicating consent).

S102: After obtaining the customer's consent regarding recording, the controller 10 starts the imaging by the imager 11.

S103: The controller 10 determines whether the predetermined condition is met. If the predetermined condition is met (S103-YES), the process proceeds to S104. If the predetermined condition is not met (S103-NO), the process ends.

In this embodiment, the predetermined condition includes a first condition that the staff is reflected in the image of the imager 11. The image may be captured by the in-camera of the imager 11, for example. The controller 10 may execute the determination of the first condition using any object detection technology such as You Only Look Once (YOLO) and a convolutional neural network (CNN). Alternatively, the first condition may be a condition that the customer is reflected in the image of the imager 11. The image may be captured by the out-camera of the imager 11, for example.

The predetermined condition may further include a second condition that the input interface 12 can acquire audio in the background, and that a start phrase suggesting starting engagement with the customer is detected from the utterance input to the input interface 12. If both the first condition and the second condition are met, the process may proceed to S104.

While acquiring audio in the background, the controller 10 does not perform recording. The start phrase may be pre-stored in the memory 15. The controller 10 may detect the start phrase by comparing the phrases stored in the memory 15 with the content of the utterance. The comparison may utilize natural language processing such as morphological analysis, syntactic analysis, semantic analysis, contextual analysis, and co-reference analysis, along with a learning model trained in advance by machine learning. The learning model may be trained to take the content of the utterance as input and output the comparison result with the phrases stored in the memory 15. The features of the learning model may be specific words or phrases, such as greetings or self-introductions, including staff names used in expressions like "Thank you in advance."

The start phrase may include phrases that are likely to be spoken by staff at the beginning of customer engagement, such as greetings to customers like, "Thank you for your cooperation," or phrases that indicate the staff's self-introduction, such as, "I am (name) and I will be in charge of you." By setting such phrases as the start phrase, it ensures that recording is executed even if the staff forgets to perform the recording operation. The start phrase may include any phrase that may be uttered by the customer. The start phrase is not limited to the above examples and may include any phrase.

The controller 10 may display the start phrase on the display 13 to prompt the staff to utter the start phrase. This allows the staff to reliably speak the start phrase and ensure that the interruption operation is executed even if they forget to say the start phrase or forget the content of the start phrase.

Controller 10 starts audio recording. The process then ends.

Specifically, controller 10 records the voices of staff and customers input through the microphone of input interface 12.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like contained in each component, each step, or the like can be rearranged without logical inconsistency, and a plurality of components, steps, or the like can be combined into one or divided.

For example, an embodiment in which the configuration and operations of the information processing apparatus 1 in the above embodiment are distributed to multiple computers capable of communicating with each other can be implemented. For example, the configuration and operations of information processing apparatus 1 may be distributed between a server apparatus and one or more terminal apparatuses.

1. A method executed by an information processing apparatus that includes a controller, an imager, and an input interface, the method comprising executing, by the controller, operations including:
acquiring consent from a customer regarding recording of customer engagement audio via the input interface;
starting capturing an image using the imager after the consent is acquired; and
starting audio recording when a predetermined condition is met,
wherein the predetermined condition includes a first condition that a staff member is reflected in an image of the imager.

2. The method according to claim 1, wherein the predetermined condition includes a second condition that the controller is capable of acquiring audio in background from the input interface, and that a start phrase suggesting starting engagement with the customer has been detected from an utterance input to the input interface.

3. The method according to claim 2, wherein the start phrase includes a phrase indicating a greeting or self-introduction to the customer.

4. The method according to claim 2, wherein
the information processing apparatus further includes a display, and
the operations further include displaying the start phrase on the display.

5. The method according to claim 1, wherein the acquiring of the consent includes detecting a consent phrase suggesting the consent from an utterance input to the input interface.
